(19) United States
(12) Patent Application Publication
(10) Pub. No.: US 2008/0199713 A1
(43) Pub. Date: Aug. 21, 2008

(54) Powder Coating Composition

(76) Inventor: David Murray James, Burwood (AU)

Correspondence Address: ARENT FOX LLP, 1050 CONNECTICUT AVENUE, N.W., SUITE 400, WASHINGTON, DC, 20036, US

(21) Appl. No.: 11/632,061

(22) PCT Filed: Jul. 14, 2005
(86) PCT No.: PCT/AU05/01034

§ 371 Date: Feb. 5, 2008

(30) Foreign Application Priority Data
Jul. 14, 2004 (AU) 2004903881

(51) Int. Cl. B32B 21/08

(52) U.S. Cl. 428/511

(57) ABSTRACT

A powder coating composition comprising rubber modified epoxy resin.

### FIELD OF THE INVENTION

The present invention relates to an additive for powder coating compositions intended for use on engineered wood substrates, and in particular medium density fibreboard (MDF). The invention also relates to a powder coating composition having elastic properties suitable for use on MDF and other engineered wood substrates.

### BACKGROUND OF THE INVENTION

There are a large number of different types of engineered wood products. Reconstituted wood substrate (RWS) is produced from wood particles, fibres, flakes or chips. RWS is produced by combining the particles, fibres, flakes or chips with a binder and compressing into a sheet to form hardboard, medium density fibreboard (MDF), wafer board, flake board, chip board and particle board. Plywood is another engineered wood and is a laminate formed from joining relatively thin layers of veneer together, with the grain of adjacent layers at right angles. Plywood may have a core of RWS.

Many uses have been suggested for powder coated MDF, plywood, particle board and other engineered woods. It is becoming more difficult to obtain large panels of natural wood, particularly hardwood. In theory, engineered woods could be powder coated with a wide range of coating compositions to provide a long lasting coating with a desirable appearance. MDF could be powder coated to form panels with a metallic, wood grain, stone or other finish. Such panels could be used in furniture such as built-in cupboards, cabinets and benches such as those used in the home kitchen, or other furniture such as tables, TV stands, chairs, bookcases and office furniture.

However, it is difficult to successfully powder coat engineered woods or other substrates which are temperature sensitive. Traditional powder coating methods fuse and cure the powder coating at temperatures over 180° C. Such temperatures are unacceptable for woods, particularly engineered woods, as it can damage the strength of the end product.

The curing temperatures can also result in distortion or internal splitting (checking) of the wood product and outgassing which results in surface defects such as pin holing and poor adhesion. These defects are generally as a result of the release of moisture and/or other gases from the substrate. A further problem is poor coverage at the edges of the coated substrate, known as the edge effect.

Although there are some solutions to the above problems, there remain significant difficulties for the production of acceptable powder coated engineered woods and this has hindered the commercial acceptance and use of powder coated engineered woods.

In particular there is an ongoing problem with edge cracking of the coating, particularly with MDF, and to a lesser extent with other engineered woods. This is thought to be due to the expansion and contraction of the substrate due to the presence of moisture. Composite materials such as MDF contain fibres together with resin binders, water and other additives. Water may comprise between 4 to 10% by weight of the MDF panels, and its presence is important in order to improve conductivity of the substrate.

During the curing process the MDF may be subjected to low temperature heating at or around 140° C. The coating may crack or blister during the curing stage because of outgassing of vapors about the edges of the MDF panels, particularly when the substrate has a significant moisture content. Degassing or blowing agents can reduce the likelihood of cracking and pinholing caused by outgassing.

In addition to the outgassing problem, during the curing process the heated MDF will initially expand but will then contract as the water evaporates from the heated substrate. The contraction will continue as the MDF panel cools back down to room temperature. The majority of the expansion and subsequent contraction of the MDF will happen in the thickness dimension of the panel and may also cause edge cracking.

The moisture content in the coated MDF will normally over time equilibrate with the ambient atmospheric moisture content. The amount of time required will depend on the extent of coating coverage, the thickness of the coating and the moisture permeability of the coating. Changes in temperature, such as those caused by changes in atmospheric conditions or localized changes, can also cause in the expansion and contraction of the MDF. The substrate may be subjected to a daily cycle of expansion and contraction, which can strain and ultimately crack the edge coating. For example, MDF panels used in a kitchen may be subjected to localized temperature changes due to the proximity to the oven, or by heat transfer from hot saucepans or frozen foods. Items of furniture may be warmed during the day by heating systems used to warm the home and allowed to cool during the night.

Thus the coating may crack during the curing process, during the cooling period after curing or due to post curing expansion and contraction effects. There are a number of factors which may affect whether or not the coating will crack, including the physical properties of the coating and the MDF panel, the MDF moisture content, the thickness of the coating and degree of coverage and the environmental conditions of the intended use. The ‘edge effect’, whereby thickness of coating at or near the edges of the substrate is less than that elsewhere on the substrate may also be a contributing factor to edge cracking.

### SUMMARY OF THE INVENTION

In an embodiment of the invention there is provided a powder coating composition for use on engineered woods, the composition comprising rubber modified epoxy resin.

Preferably, the composition also comprises polyester and/or epoxy polymers and a cross-linking agent.

In an embodiment of the invention there is provided a method of powder coating engineered woods wherein a powder coating composition containing rubber modified epoxy resin is applied to the engineered wood.

In an embodiment of the invention there is provided the use of rubber modified epoxy resin in powder coating compositions for application to engineered woods.

In an embodiment of the invention there is provided a powder coated engineered wood, wherein the powder coating includes sufficient rubber modified epoxy resin to prevent edge cracking.

Preferably the rubber modified epoxy resin is an adduct of carboxyl terminated butadiene-acrylonitrile with an epoxy resin (CTBN epoxy resin). Preferably, the rubber modified epoxy resin is bisphenol A epoxies modified with CBTN. Most preferably it is Kukdo KR-102L, Kukdo KR-104L or RSS-1704.

Preferably the crosslinker has a flexible structure. Preferably, the crosslinker is Epicure 4501.

Preferably the engineered wood is MDF.

### DETAILED DESCRIPTION OF THE INVENTION

The present invention relates to the surprising finding that it is possible to avoid or reduce the post cure edge cracking problems which can occur when powder coating MDF and other engineered woods by including rubber-modified epoxy resins in powder coating compositions.

The term “powder coating” is often used with different meanings in the art. It may refer to the act of forming a powder coated substrate, the powder composition or formulation used in the formation of the coating or to the formed and cured coating layer. To avoid any confusion the terms “powder particles”, “powder coating composition” and “powder coating formulation” refer to the powdered composition and “powder coating” refers to the application and curing process or the formed and cured layer on the substrate.

Rubber-modified epoxy resins are well known and have traditionally been used in adhesive compositions for use in adhering metal, plastic and glass materials. Carboxyl-terminated butadiene-acrylonitrile copolymers have also been blended with epoxies to toughen the otherwise brittle curing epoxy polymers. Various rubber-modified epoxies are mentioned in Rubber-Modified Thermoset Resins, American Chemical Society (1984).

A rubber-modified epoxy resin can be nitrile rubber functionalized with epoxy groups. Nitrile rubber (before epoxy functionalization) is a copolymer of aliphatic dienes and acrylonitrile or methacrylonitrile, preferably acrylonitrile.

The aliphatic dienes preferably have from about 4 to about 12, preferably from about 4 to about 10, more preferably from about 4 to about 8, carbon atoms per molecule. Particularly suitable diunsaturated hydrocarbon include, for example, butadiene, pentadiene, hexadiene, heptadiene, octadiene, isomers of the above, combinations thereof and the like. Butadiene is the most preferred diene.

Rubber-modified epoxy resins may be formed by combining a carboxyl-terminated aliphatic diene acrylonitrile or methacrylonitrile copolymer with a suitable epoxy functionalizing compound, such as the diglycidyl ether of bisphenol-A. A range of epoxy functionalized compounds could be used such as bisphenol A type epoxy resins, bisphenol F type epoxy resins, bisphenol AD type epoxy resins, bisphenol S type epoxy resins and epoxy resins prepared by hydrogenating the same, glycidyl ester type epoxy resins, glycidylamine type epoxy resins, alicyclic epoxy resins, novolak type epoxy resins, urethane-modified epoxy resins having urethane bond and fluorinated epoxy resins.

The carboxyl-terminated aliphatic diene acrylonitrile or methacrylonitrile copolymers can be obtained commercially or may be manufactured on site. The preferred copolymers are carboxyl terminated butadiene-acrylonitrile or (meth)acrylonitrile copolymers, and these types of copolymers are well known, commercially available chemicals. Typically, the reactive butadiene-acrylonitrile liquid elastomer is mixed with an epoxy resin and heated to a temperature in the range from 150° C. to 200° C., generally in the presence of a catalyst such as triphenyl phosphine. The reactive groups in the rubber react with the epoxy resin to produce epoxy-rubber chains with epoxy-functionality.

Particularly preferred are the rubber-modified epoxy resins sold under the brands Kukdo KR-102L, Kukdo KR-104L and RSS-1704. These are commercially available rubber-modified epoxy resins and can be successfully used in powder coating compositions.

A number of other types of rubbers may be used in the formation of the rubber-modified epoxy resins. For example, functionalized forms of silicon rubbers, ethylene-propylene dienes (EPDM), butyl rubbers, polychloroprenes may be used instead of the nitrile rubbers.

Although carboxyl functionalized groups are preferred, other types of functional groups could be used such as amino terminated, hydroxy terminated and vinyl terminated. The vinyl functionality will not normally react with an epoxy functionalizing compound, but instead require another mechanism for coupling a rubber containing vinyl functionality together with the epoxy functionalizing compound. Epoxy terminated butadiene acrylonitrile, amino terminated butadiene acrylonitrile and vinyl terminated butadiene acrylonitrile copolymers are commercially available and may be used. Of these CTBN copolymers are preferred because of their miscibility with epoxy polymers, their stability and the ease by which the rubber-modified epoxy resin adduct can be formed.

The rubber-modified epoxy resins can provide sufficient flexibility to the powder coating composition so it can cope with the expansion and contraction of the engineered wood such as MDF.

The rubber-modified epoxy resins may be cured at ambient or elevated temperatures, depending on the curing agent used with the epoxy. Some of the most widely used curatives are polyamines, anhydrides, polyamides, mercaptans, phenolic resins, tertiary amines and Lewis acids.

Suitable curing (cross-linking) agents for use in the composition can be commercially obtained and include, for example, aromatic, cycloaliphatic, and aliphatic amines, aromatic, cycloaliphatic, and aliphatic polycarboxylic acids and anhydrides thereof, guanadines, biguanides, aromatic hydroxyl-containing compounds, aromatic hydroxyl-containing phenol or substituted phenol-aldehyde novolac resins, diunsaturated aliphatic- or diunsaturated cycloaliphatic-phenol or substituted phenol resins, dicyandiamide and adducts of 2-methyl imidazole, combinations thereof and the like.

The preferred curing agents include those sold under the brands Epicure 4501, SMA-1440 and Vestagon B31. Of these crosslinkers, Epicure 4501 can provide particularly good results. It is believed SMA-1440, a styrene maleic anhydride crosslinker, is less flexible in its structure but may be useful on substrates which expand and contract less than MDF.

Preferably, a substantial amount of the rubber modified epoxy resin has at least two epoxy groups in order to provide a good cross-linked structure when the coating is cured. More preferably at least a majority of the polymer chains of the rubber modified epoxy resin has at least two epoxy groups.

Preferably, the powder coating composition contains from 2% to 65% by weight of rubber modified epoxy resin. Different compositions may be effective with different amounts of the rubber modified epoxy resin as it depends the flexibility of the coating and the expansion/contraction characteristics of the substrate. It is thought that if the composition has less than 2% or 3% of rubber modified epoxy then it may not be sufficiently flexible. The composition may include over 65% by weight of rubber modified epoxy, but this can cause milling problems due to a low Tg.

Preferably the degree of cross linking within the polymer after curing is over 60%, more preferably over 80% and more preferably near or at 100%. With these powder coating compositions it is believed the degree of cross-linking directly correlates with flexibility, so that greater flexibility is obtained at 100% cross-linking than at 60%.

The rubber-modified epoxy polymer may be a blend of two or more rubber-modified epoxies. The rubber-modified epoxy polymer may be used alone to provide the polymer component of the powder coating, or in conjunction with other polymers, such as epoxy and/or polyester resins. The polymer may be incorporated into existing low-temperature cure powder coating compositions for use on engineered woods such as MDF. Such compositions may be commercially available powder coating compositions and may be based or adapted from those used to coat other engineered woods, such as particle board, as known to the art. Two useful references which may provide guidance on the matter are Volume 1 of Powder Coatings: The Technology, Formulation and Application of Powder Coatings by David M Howell, John Wiley & Sons Ltd, London, 2000 and The Technology of Powder Coatings by S. T. Harris, Portcullis Press Ltd, Surrey UK, 1976.

Typically, the powder coating composition will contain a combination of rubber-modified epoxy and epoxy or polyester polymers. It is preferred to limit the use of the coated substrates to internal applications as epoxy polymer systems can exhibit significant color and structure degradation with long term exposure to sunlight.

The powder coating composition may contain a degassing agent. A degassing agent allows the venting of volatile gases from the substrate during the fusing and curing stages of the powder coating process and thereby can prevent pinholing and other damage to the coating. The degassing agent should be present in an amount of from 0.2 to 4% by weight. The Powdermate 542DG and Benzoin products are preferred as they generally provide good results, although others such as Oxymelt may be used. The Benzoin product is preferably present in an amount of from 0.3% to 1%, more preferably about 0.5%. The Powdermate product is preferably present in an amount of from 1% to 3%, more preferably about 1% by weight.

The composition may contain colour pigments, extender pigments and other additives. Examples of pigments and fillers include metal oxides, such as titanium oxide, iron oxide, zinc oxide and the like, metal hydroxides, metal powders, sulphides, sulphates, carbonates, silicates such as aluminum silicate, carbon black, talc, kaolins, barytes, iron blues, lead blues, organic reds, organic maroons and the like. The pigment (including extender pigment) can comprise up to 40% of the composition depending on color.

Pigments can be used to provide a broad range of surface appearances or effects. Mica-, alumina- and silica-based pigments may be used to provide a copper, red, green, gold and other colors. A gun-metal grey surface can be provided by using various black shades. Bismuth oxychloride crystals can be used to provide a pearl like coloration for marble effects. The pigments may be omitted and instead the underlying MDF can be stained to give a desired natural wood appearance before powder coating with a transparent composition.

A slip-enhancing additive may be included to improve coating wear characteristics such as that described in U.S. Pat. No. 5,925,698. Powder coating compositions may contain other coating modifiers such as polytetrafluoroethylene modified waxes, polyethylene waxes, polypropylene waxes, polyamide waxes, organosilicones and blends of the above. Polytetrafluoroethylenes (PTFE) may be used as a slip-enhancer/coating modifier. The inclusion of significant amounts (0.2% by weight or greater) of Telfon or other PTFEs such as Dyneon TF1641 or Ceraflour 969 may also provide other benefits, not limited to scratch resistance. It is thought the inclusion of 1 or 2% by weight of PTFE may improve the bonding between the substrate and powder coating composition.

The powder coating process involves applying the powder coating composition to the substrate, typically by electrostatic coating techniques, and then fusing and curing the powder so the particles melt, flow and fuse together and transform into a smooth, typically high gloss, coating. It is an environmentally friendly method of applying a coating because a solvent is not required and the overspray particles that are not bonded to a substrate can be collected and re-used in the next powder coating application. It is envisaged that a broad range of powder coating compositions and application methods could be used.

As earlier mentioned there are a number of problems with powder coating wood based substrates. The electrostatic coating techniques act by charging the particles and require the substrate to be coated to hold an opposite charge. Whilst this works well with metals, it is more difficult to form and hold the required charge on wooden substrates, particularly at the edges. Obtaining satisfactory coverage at and near the edges is important, particular when coating pre-shaped wooden blanks to avoid the need for additional coating steps.

It can be helpful to improve charge retention by pre-heating the substrate sheets to a temperature over 80° C. This increases the amount of water at or near the surface of the sheets and permits a charge to be more easily held. Other techniques that may be used include applying a brief burst of water or steam to the sheets or applying a conductive coating to the substrate. The latter approach has some disadvantages, not the least being the requirement of an additional step and the waste, solvents and drying time associated therewith.

Another method for improving charge retention is to incorporate sufficient amounts of electrically conductive materials within the substrate. The use of metal powders, inorganic salts such as sodium chloride, carbon black and other conductive materials as additives to the composite may significantly enhance charge retention.

Another difficulty with coating engineered woods is that the substrate wood can be damaged by the use of high temperatures or by the application of moderate heat over a prolonged period. The MDF can suffer mechanical changes when heated over 150° C. Thus, it is preferred to apply the powder coating composition using electrostatic techniques and in a way which minimizes unnecessary heating of the substrate sheets during the curing of the coating. The preferred method involves the powder coating compositions which cure at low temperatures.

The powder coating process may also include other techniques used to avoid the application of excessive heat to the substrate. It can be useful to pre-heat the substrate for a short time at a moderate heat, for example, by 2 to 10 minutes (preferably 5 minute) at 60 to 80° C. (preferably 70° C.). The use of a burst of steam shortly before coating may also preheat the substrate and improve charge retention. Low temperature curing techniques can be enhanced by the use of localized heating with IR lamps which reduce the heat exposure of the underlying substrate. Hg containing lamps have been found to be effective for UV curing.

Powder coating compositions are generally prepared by adding the required amounts of the raw materials into a premixer in which the ingredients are mechanically mixed, usually with a metal blade, to form a homogeneous mixture. This premix material passes through an extruding process. In this process the mixture is processed under heat (usually between 80° C. and 140° C.) and compounded using mechanical shear. This causes the powder coating composition to melt and act like a semi-liquid, and allows the ingredients to be intimately mixed into the powder coating composition. After leaving the extruder the material is cooled, generally on a chiller belt. The cooled mixture is then milled (ground) to the required particle size distribution for good application. A standard particle size distribution ranges from 2 to 200 microns, preferably 10 to 150 microns and typically around a medium size of 40-60 microns.

The powder coating composition can be applied to the substrate by any suitable technique. The two major techniques used are the corona electrostatic technique and the triboelectrostatic technique. According to the corona electrostatic technique the powder particles are given an electric charge as they come out of the end of a powder coating corona gun by electrodes located at the end of the gun tube. The electrodes are powered by a power-pack which can generate up to 100,000 V (100 KV). The usual working range for voltage is 50 to 100 KV. The powder is sprayed (powder is carried in a stream of air) at the earthed composite panel. The charge on the powder particles allows the powder particles to adhere to the substrate. After the powder coating is sprayed, a baking process is required to melt and fuse the powders together and also chemically react and cross-link (creating a thermoset paint finish) the polymers in powder coating composition and the cross-linker(s).

The triboelectrostatic technique involves a tribogun which also works by charging the powder particles towards an earthed panel. The charge in this case is not generated by a power pack. The tribogun is generally a long polytetrafluoroethylene tube. Friction is generated between the powder coating and the PTFE tube and a charge on the powder is generated by electron removal.

Other powder application techniques are known and could also be used to apply the powder coating composition to the substrate. A technique that could be used is described in U.S. Pat. No. 6,342,273 (Handels, et al.). The technique involves first charging the powder particles by friction or induction in the presence of carrier particles, feeding the charged powder and carrier particles to a transporter, transferring the charged powder particles from the transporter onto a transfer medium and then applying the powder particles from the transfer medium to the substrate.

Vertical (hanging substrate) or horizontal coating systems could be used in the coating process. Each system has advantages. Horizontal powder coating systems, such as that described in US 2003/0211252, may be of particular use with longer lengths of the substrate than could be reasonably attached to a hanging conveying system and should permit the powder coating of the main contact face and edge faces. Hanging systems allow the substrate to be entirely coated in a single pass with multiple electrostatic guns that apply the powder to all sides. Alternatively, electrostatic guns could be used to spray the powder on at least one face of a suspended substrate. Horizontal systems can be used to provide a wholly coated substrate in sequential powder coating steps. Horizontal systems can also allow the use of alternative powder delivery techniques such as fluidized beds or allowing powder to fall onto the substrate, by using for example a vibratory hopper.

The coating powder is typically applied to achieve a cured thickness of 0.04 to 0.6 mm, and preferably less than 0.15 mm (6 mils). The powder is typically applied at a thickness of from 0.08 mm to 0.13 mm. The substrate could be coated with multiple layers to increase the thickness of the coating.

The powder coating composition can be used to provide a single finished coat or as a primer coat, which may omit pigments, and which is subsequently coated with top layer. It can be beneficial to use multiple layers as this should provide a thicker overall coating and improve the durability and water resistance of the overall product. It can also be used to provide a smooth surface finish on the product. When the primer layer includes significant amounts of a texture additive, such as Bentone, then the primer layer can be sanded smooth before the application of the topcoat. The use of a primer powder coating layer may significantly reduce the need to pre-sand the uncoated substrate and provide a good top surface finish.

The powder coating composition could be used on a range of substrates, including the earlier listed engineered woods, but also may be useful on other types of substrates including metals, glass and plastics. The preferred substrate is engineered woods, and most preferably MDF.

The size and dimensions of the substrate can vary widely. For example, the length of each sheet may be from 100 mm to 3500 mm. The width may vary from 30 mm to 2000 mm. The thickness may be, for example, from 2 mm to 150 mm.

The application and curing methods depend on the type of the powder coating composition. A technique for powder coating MDF and other engineered woods involves the use of UV curable powder coatings. With such coating compositions, the powder is applied to the substrate and heated to and above the melting point of the powder coating composition. The temperature achieved in the melting phase is usually between 90° C. and 160° C. The melting phase is conducted by either infrared (IR) heating oven or convection gas or electric heating oven, or a combination of the two systems. After melting and fusing stage, the coated panel is then passed under UV cure oven. At this stage the coating is irradiated with UV light. The light is generated by either a mercury lamp or a gallium doped mercury lamp with wavelengths of between 205 and 405 nm.

Photo-initiators suitable for inclusion in UV powders include aromatic carbonyl compounds, such as benzophenone and alkylated or halogenated derivatives, anthraquinone and its derivatives, thioxanthone and its derivatives, benzoin ethers, aromatic or non-aromatic alphadiones, benzol dialkyl acetals, acetophenone derivatives and phosphine oxides.

The UV cure powder coating compositions can be applied to the substrate using similar techniques to standard coatings which require baking.

Low bake powder coatings are designed to cure at temperatures between 90° C. (or less) and 160° C. for between 10 and 40 minutes total oven time (in a conventional gas or electric fired oven). IR cure of low bake powder will be much faster (from 30 seconds to 5 minutes). Epoxy and acrylic (polyester) resins are commonly used.

Some examples of some typical powder coating compositions of the invention are provided below.

Typical Low Temperature Cure Polyester/Rubber-Modified Epoxy Formulation

| | |
|---|---|
| Polyester | 10-50% |
| Rubber-modified epoxy | 10-50% |
| Degassing agent | 0.2-4% |
| Cross-linker | 1-16% |
| Pigments | 1-30% depending on colour |
| Flow additive | 0-3% |
| Other additives | 0-5% as required |

The polyester resin usually has the following properties:

| | |
|---|---|
| Acid Value (or hydroxy value) | 20-80 |
| Viscosity | 200-700 dPa · s (at 165° C.) |
| Glass Transition Temperature | 50-70° C. |

The rubber-modified epoxy polymer usually has the following properties:

| | |
|---|---|
| Epoxy equivalent weight (EEW) | 400-1400 |
| Viscosity | |
| Glass Transition Temperature | >40 C. |

Typical Low Temperature Cure Epoxy Formulation

| | |
|---|---|
| Pigments | 0-40% |
| Rubber-modified epoxy | 10-90% |
| Epoxy resin (non-modified) | 0-80% |
| Cross-Linker | 0-16% |
| Additives | 0-10% |

The epoxy resin (non-modified) generally has the following properties:

| | |
|---|---|
| Epoxide equivalent weight: | 400-900 |
| Viscosity: | 500-5000 Centistokes at 150° C. |
| Softening point: | 70-110° C. |

The present invention will now be described with reference to the following non-limiting examples.

### EXAMPLES

Unless otherwise indicated the mixtures were prepared by combining the ingredients (polymers, cross-linkers, color pigments, extenders, flow additives and other minor additives). The mixture was then agitated and then heated and extruded at 100° C. to provide a homogeneous sheet. The sheet was cooled, granulated and then milled and sieved to provide particles having a particle size less than 125 micrometers (average particle size of 40 microns) to provide the powder coating composition. All amounts are parts by weight.

The powder coating compositions were applied electrostatically to the substrate material (all sides were coated) and cured. Heat curing involved the use of an IR oven and/or a convection oven.

TABLE 1
Low Temperature Cure Formulations

| | Formulation No. | | | | |
|---|---|---|---|---|---|
| | A | B | 1 | 2 | 3 |
| Polyester resin | 35 | 35 | 28.4 | 35 | 30.8 |
| (Uralac P2980) | | | | | |
| Epoxy Resin | 35 | — | — | — | — |
| (DER 6224) | | | | | |
| Epoxy Resin | — | 35 | — | — | — |
| (DER 642U) | | | | | |
| Rubber-modified | — | — | 42.6 | — | — |
| Epoxy polymer | | | | | |
| (Kukdo KR-104L) | | | | | |
| Rubber-modified | — | — | — | 35 | — |
| Epoxy polymer | | | | | |
| (Kukdo KR-102L) | | | | | |
| Rubber-modified | — | — | — | — | 40.2 |
| Epoxy polymer | | | | | |
| (RSS-1704) | | | | | |
| Cross-linker | 1.4 | 1.4 | 1.4 | 1.4 | 1.4 |
| (Vestagon B31) | | | | | |
| Flow controller | 1 | 1 | 1 | 1 | 1 |
| (Resiflow PL200) | | | | | |
| Degassing agent | — | 0.5 | — | — | — |
| (Benzoin) | | | | | |
| Pigment | 26 | 26 | 26 | 26 | 26 |
| (Titanium Dioxide) | | | | | |
| Fluidising Agent | 0.2 | 0.2 | 0.2 | 0.2 | 0.2 |
| (Aluminium Oxide) | | | | | |

Coating formulations A and B are comparative formulations and omit a rubber-modified epoxy resin. Coating formulation 1 to 3 are of the invention and include rubber-modified epoxy resins—namely Kukdo KR-102L, Kukdo KR-104L and RSS-1704.

All coating formulations were sprayed onto 18, 25 and 33 mm Trimatrx® grade MDF test panels and then cured for 20 minutes at 150° C. in a convection oven.

All coating formulations were also sprayed onto 18, 25 and 33 mm Trimatrx® grade MDF test panels and then cured using Infra Red oven (Hotco Medium Wave oven) for 4 minutes.

All coated test panels were examined and appeared to be adequately coated. Curing was further assessed uses a solvent resistance test and the powder coatings on all test samples were considered to be satisfactorily cured.

All coated test panels were tested for expansion and edge cracking. The panels were placed in a humidity chamber at 100% relative humidity at 38° C. The panels were periodically inspected for signs of expansion and edge cracking.

After 10 days in the humidity chamber, the test panels coated with formulations 1-3 showed no signs of edge cracking on all thickness sizes of Trimatrx MDF. In contrast, all test panels coated with formulations A and B showed multiple cracking along all the edges for all three MDF sizes 18, 25 and 33 mm and both curing methods.

The test results indicated that flexible epoxy resins (Kukdo KR-104L, Kukdo KR-102L, RSS-1704) provided improved edge cracking resistance.

TABLE 2
Additional Low Temperature Cure Formulations

| Formulation No. | | | | | | |
|---|---|---|---|---|---|---|
| D | E | 4 | 5 | 6 | 7 | 8 |

| | | | | | | | |
|---|---|---|---|---|---|---|---|
| Polyester resin | — | — | — | — | — | — | 5 |
| (Uralac P2980) | | | | | | | |
| Epoxy Resin | 52 | — | — | — | 25.8 | 41.8 | 41.8 |
| (DER 6224) | | | | | | | |
| Rubber-modified | — | 56 | 57.4 | 57.4 | 29 | 11.8 | 11.8 |
| Epoxy polymer | | | | | | | |
| (Kukdo KR-104L) | | | | | | | |
| Cross-linker | 18 | — | 12.6 | 12.6 | 15.1 | 17.3 | 17.3 |
| (Epicure 4501) | | | | | | | |
| Cross-linker | — | 14 | — | — | — | — | — |
| (SMA-1440) | | | | | | | |
| Cross-linker | 1.4 | 1.4 | 1.4 | 2.8 | 2.8 | 2 | 2.8 |
| (Vestagon B31) | | | | | | | |
| Flow controller | 1 | 1 | 1 | 1 | 1 | 1 | 1 |
| (Resiflow PL200) | | | | | | | |
| Degassing agent | — | — | — | 0.5 | — | — | — |
| (Benzoin) | | | | | | | |
| Pigment | 26 | 26 | 26 | 26 | 26 | 26 | 21 |
| (Titanium Dioxide) | | | | | | | |
| Fluidising Agent | 0.2 | 0.2 | 0.2 | 0.2 | 0.2 | 0.2 | 0.2 |
| (Aluminium Oxide) | | | | | | | |

Experiments were conducted to examine the effect of using matting cross-linkers (Epicure 4501, SMA-1440 and Vestagon B31) on the flexibility, edge cracking and appearance of the coated film on MDF.

All formulations were sprayed onto 18, 25 and 33 mm Trimatrx® MDF test panels and cured for 20 minutes at 150° C. in a convection oven.

All formulations were also sprayed onto 18, 25 and 33 mm Trimatrx® MDF test panels and cured by Infra Red oven (Hotco Medium Wave oven) for 4 minutes.

All coated test panels were examined and appeared to be adequately coated. Curing was further assessed using a solvent resistance test. The test panels coated with comparative formulation D and cured by convection baking showed some softening and were considered to be undercured. The other test panels, including those with formulation D when cured by IR were considered to be satisfactorily cured.

All coated tested panels were tested for expansion and edge cracking. The panels were placed in a humidity chamber at 100% relative humidity at 38° C. The panels were periodically inspected for signs of expansion and edge cracking.

After 10 days in the humidity chamber, the test panels coated with formulations 4, 5, 6 and 8 showed no signs of edge cracking on all thickness sizes of the MDF. The test panels coated with formulations D and E showed multiple cracking along all the edges for all test panels.

Formulation E may have failed due to the use of the less flexible cross-linker SMA-1110. However, formulation E did cure well and provided a good film and may be useful on substrates which expand less.

The test panel coated with formulation 7 showed slight signs of edge cracking. This was attributed to the use of a lower amount of rubber modified epoxy and higher TiO₂ content.

The inclusion of flexible epoxy resins (Kukdo KR-104L, Kukdo KR-102L, RSS-1704) in the powder coating composition showed improved edge cracking resistance, particularly with suitable matting cross-linkers.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form or suggestion that that prior art forms part of the common general knowledge in Australia.

It would be appreciated by a person skilled in the art that variations and/or modifications may be made to the invention as described without departing from the spirit or scope of the invention as broadly described. The described embodiments are, therefore, to be considered in all respects as illustrative and not restrictive.

1. A powder coated engineered wood, wherein the powder coating composition comprises rubber modified epoxy resin.

2. The engineered wood according to claim 1, wherein the rubber modified epoxy resin is the adduct of carboxyl terminated butadiene-acrylonitrile with an epoxy (CTBN epoxy).

3. The engineered wood according to claim 1, wherein the rubber modified epoxy resin is the adduct of bisphenol A epoxy modified with CBTN.

4. The engineered wood according to claim 1, wherein the rubber modified epoxy resin is Kukdo KR-102L, Kukdo KR-104L or RSS-1704.

5. The engineered wood according to claim 1, wherein the powder coating composition also comprises polyester and/or epoxy polymers and a cross-linking agent.

6. The engineered wood according to claim 5, wherein the crosslinking agent has a flexible structure.

7. The engineered wood according to claim 6, wherein the crosslinking agent is selected from the group consisting of Epicure 4501, SMA-1440 and Vestagon B31.

8. The engineered wood according to claim 1, wherein the rubber modified epoxy resin comprises from 2% to 65% by weight of the powder coating composition.

9. The engineered wood according to claim 1, wherein the powder coating composition comprises from 0.2 to 4% by weight of a degassing agent.

10. The engineered wood of claim 9, wherein degassing agent is selected from the group consisting of Powdermate 542DG, Benzoin and Oxymelt.

11. (canceled)

12. (canceled)

13. (canceled)

14. (canceled)

15. (canceled)

16. A powder coated engineered wood, wherein the powder coat comprises rubber modified epoxy resin in a sufficient amount to prevent edge cracking.

17. The powder coated engineered wood according to claim 1, wherein the powder coat comprises rubber modified epoxy resin in a sufficient amount to prevent edge cracking.

18. A method of powder coating engineered wood comprising applying a powder coating composition to the engineered wood, wherein the powder coating composition comprises a rubber modified epoxy resin.

19. The method according to claim 18, wherein a powder coated engineered wood is produced.

20. A method of reducing or preventing edge cracking in a powder coating formed from a powder coating composition applied to an engineered wood comprising incorporating into the powder coating composition a rubber modified epoxy resin.
